(19) United States
(12) Patent Application Publication
(10) Pub. No.: US 2014/0344484 A1
(43) Pub. Date: Nov. 20, 2014

(54) DETECTION SYSTEM FOR HARD DISK DRIVE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: BO TIAN, Shenzhen (CN); KANG WU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/279,443

(22) Filed: May 16, 2014

(30) Foreign Application Priority Data
May 17, 2013 (CN) 2013101832636

(51) Int. Cl. G06F 3/06

(52) U.S. Cl. CPC G06F 3/0653; G06F 3/0604; G06F 3/0676; G06F 2003/0692
USPC 710/19

(57) ABSTRACT

A detection system for detecting status of a plurality of hard disk drives includes a plurality of subsystems. Each of the subsystems includes a controller with a plurality of general purpose input output (GPIO) pins, a plurality of connectors respectively connected to the hard disk drives, a plurality of interfaces with data pins, and a plurality of indication units. Each indication unit includes a light-emitting diode (LED). When the hard disk drive disconnects from the corresponding GPIO pin of the controller or is damaged, the corresponding GPIO pin of the controller outputs a digital high signal to the corresponding indication unit, the corresponding LED is turned off.

### FIELD

The present disclosure relates to a detection system for hard disk drives.

### BACKGROUND

A multi-server system includes a plurality of subsystems. Each of the subsystems is usually connected to a plurality of hard disk drives. However, it is difficult for users to locate the hard disk which is disconnected or damaged.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an example embodiment of a detection system connecting a hard disk system, wherein the hard disk system includes a plurality of hard disk units.

FIG. 2 is a block diagram of an example embodiment of a subsystem of the detection system of FIG. 1.

FIG. 3 is an example circuit diagram of the detection system and the hard disk system.

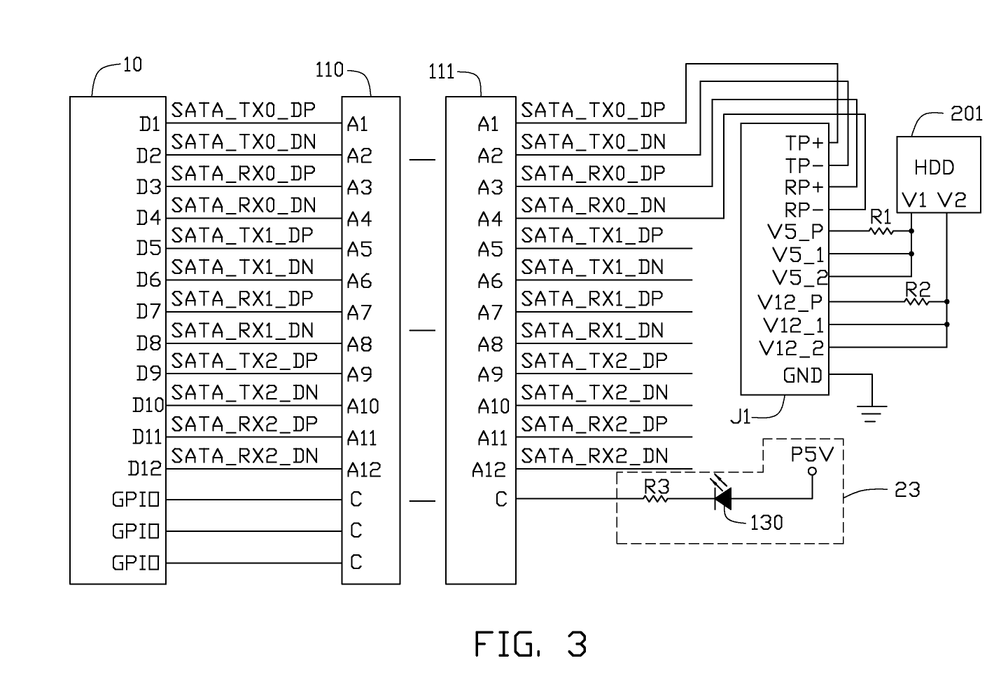

### DETAILED DESCRIPTION

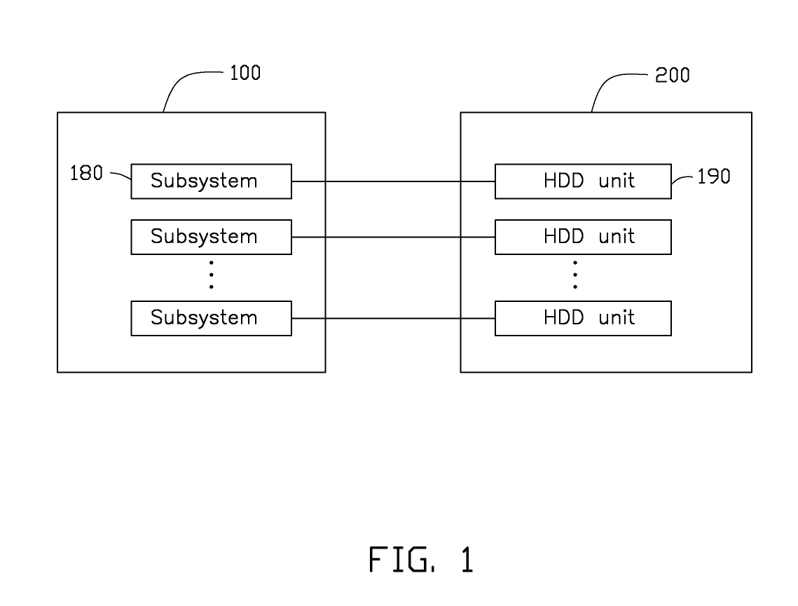

FIG. 1 is a block diagram of an embodiment of a detection system 100 for detecting a hard disk system 200. The hard disk system 200 includes a plurality of hard disk units 190. The detection system 100 includes a plurality of subsystems 180 connected to the hard disk units 190, respectively.

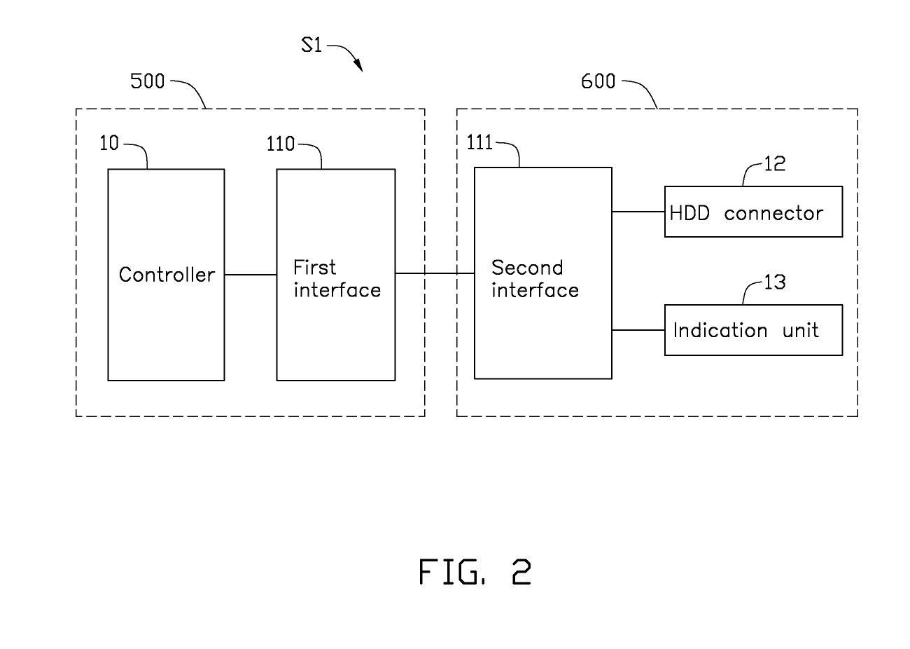

FIG. 2 illustrates a block diagram of an embodiment of the subsystem 180. The subsystem 180 includes a controller 10, a first interface 110, a second interface 111 connected to the first interface 110, a connector 12 and an indication unit 13. Each of the hard unit 190 includes a plurality of hard disk drives 201.

In the embodiment, the controller 10 is a platform controller hub (PCH). The controller 10 includes a first group data pins D1-D4 for transmitting a first group data signals SATA_TX0_DP′SATA_TX0_DN′SATA_RX0_DP′SATA_RX0_DN, a second group data pins D5-D8 for transmitting a second group data signals SATA_TX1_DP′SATA_TX1_DN′SATA_RX1_DP′SATA_RX1_DN, a third group data pins D9-D12 for transmitting a third group data signals SATA_TX2_DP′SATA_TX2_DN′SATA_RX2_DP′SATA_RX2_DN, and three general purpose input output (GPIO) pins GPIO corresponding to the first to third groups data pins D1-D4, D5-D8 and D9-D12 respectively. The first interface 110 includes first transmission pins A1-A12 connected to the data pins D1-D12 of the controller 10 respectively, and three first control pins C connected to the GPIO pins GPIO of the controller 10 respectively. The second interface 111 includes second transmission pins A1-A12 connected to the first transmission pins A1-A12 respectively, and three second control pins C connected to the first control pins C of the first interface 110, respectively.

Each of the connector 12 includes data pins TP+, TP−, RP+, RP− connecting with second transmission pins A1-A4 of the second interface 111 . A ground pin GND of the connector 12 is grounded. A first voltage pin V5_P of the connector 12 is connected to a power terminal V1 of the hard disk 201, through a resistor R1. Voltage pins V5_{—}1 and V5_{—}2 of the connector 12 are connected to the power terminal V1 of the hard disk 201. A second voltage pin V12_P of the connector 12 is connected to a power terminal V2 of the hard disk 201, through a resistor R2. Voltage pins V12_{—}1 and V12_{—}2 of the connector 12 are connected to the power terminal V2 of the hard disk 201. The power terminal V1 outputs a 5V voltage. The power terminal V2 outputs a 12V voltage.

The indication unit 13 includes a light-emitting diodes (LED) 130 and a resistor R3. An anode of the LED 130 is connected to a power source PSV. A cathode of the LED 130 is connected to one of the control pins C of the second interface 111 through the resistors R3. Light colors of the LEDs 130 of the subsystems 180 are different.

In the embodiment, both of the controller 10 and the first interface 110 are set on a motherboard 500. The second interface 111, the connector 12 and the indication unit 13 are set on a back board 600.

In use, when one hard disk drive 201 communicates with one group of the data pins of the controller 10 through the first interface 110, the second interface 111 and the connector 12, the corresponding GPIO pin of the controller 10 outputs a digital signal of logic “0” to the corresponding indication unit 13 through the corresponding control pin C of the first interface 110 and the corresponding control pin of the second interface 111. Thus, the corresponding LED 130 is turned on, for indicating the hard disk drives 201 connects normally.

When one hard disk drive 201 does not communicate with the controller 10 through the first interface 110, the second interface 111 and the connector 12, the corresponding GPIO pin outputs a digital signal of logic “1” to the corresponding indication unit 13 through the corresponding control pins C of the first interface 110 and second interface 111. Thus, the corresponding LED 130 is turned off, indicating the hard disk drive 201 is disconnecting from the connector 12 or the hard disk drive 201 is damaged. Thus, an operation status or connection status of the hard disk drive 201 can be easily and conveniently detected.

The embodiments described herein are illustrative, and are not intended to limit the scop of the following claims.

What is claimed is:

1. A detection system for detecting status of a plurality of hard disk drives, the detection system comprising a plurality of subsystems, each of the subsystems comprising:
a controller comprising a plurality of groups of data pins and a plurality of general purpose input output (GPIO) pins corresponding to the groups of the data pins respectively;
a first interface comprising a plurality of groups of first transmission pins and a plurality of first control pins, the groups of the first transmission pins respectively connected to the groups of data pins of the controller, the first control pins respectively connected to the GPIO pins of the controller;
a second interface connected to the first interface, the second interface comprising a plurality of groups of second transmission pins and a plurality of second control pins, the second control pins respectively connected to the first control pins;
a plurality of connectors respectively connected to the hard disk drives, each connector comprising a group of data pins connected to the corresponding group of second transmission pins of the second interface; and
a plurality of indication units respectively connected to the second control pins, each indication unit comprising a light-emitting diode (LED), an anode of the LED connected to a power source, a cathode of the LED connected the corresponding second control pin;
wherein when the hard disk drive connects to the controller, the corresponding GPIO pin of the controller outputs a digital low signal to the corresponding indication unit, the corresponding LED is turned on; when the hard disk drive disconnects from the controller or is damaged, the corresponding GPIO pin of the controller outputs a digital high signal to the corresponding indication unit, the corresponding LED is turned off

2. The detection system of claim 1, wherein the controller and the first interface are set on a motherboard; the second interface, the connectors and the indication units are set on a hard disk back board.

3. The detection system of claim 1, wherein light colors of the LEDs are different.

4. The detection system of claim 1, wherein the controller is a platform controller hub.
